(19) United States
(12) Patent Application Publication
(10) Pub. No.: US 2020/0159143 A1
(43) Pub. Date: May 21, 2020

(54) OPTICAL WRITING DEVICE AND IMAGE FORMING APPARATUS

(71) Applicant: KONICA MINOLTA, INC., Tokyo (JP)

(72) Inventors: Akira TANIYAMA, Tokyo (JP); Masahiko TAKAHASHI, Tokyo (JP); Naoki TAJIMA, Tokyo (JP); Takashi KUROSAWA, Tokyo (JP); Hajime TANIGUCHI, Toyokawa-shi (JP)

(73) Assignee: KONICA MINOLTA, INC., Tokyo (JP)

(21) Appl. No.: 16/673,842

(22) Filed: Nov. 4, 2019

(30) Foreign Application Priority Data
Nov. 19, 2018 (JP) 2018-216300

(51) Int. Cl. G03G 15/04; G02B 26/10

(52) U.S. Cl. CPC G03G 15/04036; G02B 26/10

(57) ABSTRACT

An optical writing device includes: a deflector that deflects and scans light; optical elements; and a housing that holds the deflector and the optical element, wherein a support plate of the housing has an enclosed inner region that is substantially surrounded by a vibration suppressor and a vibration transmission blocker and supports the deflector, and the support plate also has a flat portion having a peninsular shape facing the vibration transmission blocker in the enclosed inner region, and an element holder for at least one or more of the optical elements having optical sensitivity in a vibration direction of the housing is disposed outside the enclosed inner region.

The entire disclosure of Japanese patent Application No. 2018-216300, filed on Nov. 19, 2018, is incorporated herein by reference in its entirety.

### BACKGROUND

### Technological Field

The present invention relates to an optical writing device incorporated in an image forming apparatus such as a digital copying machine, a printer, or the like and the image forming apparatus, and more particularly relates to an optical writing device or the like using a deflection scanning method.

### Description of the Related Art

An optical writing device using a deflection scanning method deflects and scans a light beam from a light source such as a semiconductor laser by a deflector such as a polygon motor, so as to form an image as a light spot by an optical element such as a scanning lens system on an image carrying member, which is a charged photoreceptor, and moves the light spot on the image carrying member, thereby writing an electrostatic latent image.

In the optical writing device that uses the deflector for scanning a light beam on the surface of the photoreceptor, vibrations from the deflector are transmitted to the optical element through a housing of the optical writing device and vibrate the optical element. When the optical element vibrates, an image formation position on the photoreceptor also vibrates and shifts due to optical sensitivity of each optical element. When vibrations of the optical element increase, there is a concern that a shift of the image formation position on the photoreceptor becomes large and deteriorates image quality. In particular, a shift of the image formation position in a sub-direction orthogonal to a scanning direction is easily recognized as periodic pitch unevenness, and even a shift of 1 μm or less may cause a problem.

As techniques for suppressing the deterioration of image quality due to vibrations of the optical element, rigidity in the vicinity of a light source unit, which is highly sensitive for image quality, is locally enhanced so as to suppress vibrations of the light source unit (JP 10-115794 A), or a partition wall is provided between a deflector region and an optical element region so as to enhance the rigidity of a housing and suppress vibrations (JP 2001-228425 A).

The configuration of JP 10-115794 A relies only on rigidity enhancement, and vibrations from the deflector are transmitted to other optical elements, which may deteriorate image quality. Also in the configuration of JP 2001-228425 A, vibration energy of the deflector cannot be confined in the partition wall, and the vibrations are transmitted to the optical element region, which may reduce the image quality.

### SUMMARY

The present invention has been made in view of the above problems of the background art, and it is an object thereof to provide an optical writing device in which transmission of vibrations from a deflector to optical elements via a housing is suppressed, and an image forming apparatus incorporating the same.

To achieve the abovementioned object, according to an aspect of the present invention, an optical writing device reflecting one aspect of the present invention comprises: a deflector that deflects and scans light; optical elements; and a housing that holds the deflector and the optical element wherein a support plate of the housing has an enclosed inner region that is substantially surrounded by a vibration suppressor and a vibration transmission blocker and supports the deflector, and the support plate also has a flat portion having a peninsular shape facing the vibration transmission blocker in the enclosed inner region, and an element holder for at least one or more of the optical elements having optical sensitivity in a vibration direction of the housing is disposed outside the enclosed inner region.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a partial cross-sectional view illustrating a schematic configuration of an image forming apparatus of a first embodiment;

FIG. 2A is a plan view of an optical print head that is an optical writing device, and FIG. 2B is a cross-sectional view taken along a line A-A of the optical print head illustrated in FIG. 2A;

FIG. 3 is a side cross-sectional view for explaining a modification example of the optical print head illustrated in FIG. 2A and the like;

FIG. 4 is a plan view for explaining a modification example of the optical print head illustrated in FIG. 2A and the like:

FIG. 5 is a side cross-sectional view for explaining a modification example of the optical print head illustrated in FIG. 2A and the like:

FIG. 6A is a view for explaining a vibration state of a housing of the optical print head of the embodiment, and FIGS. 6B to 6D are views for explaining vibration states of housings of optical print heads of comparative examples 1 to 3, respectively:

FIG. 7 is a plan view illustrating an optical print head of a second embodiment; and

FIG. 8 is a side cross-sectional view for explaining an optical print head of a third embodiment.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

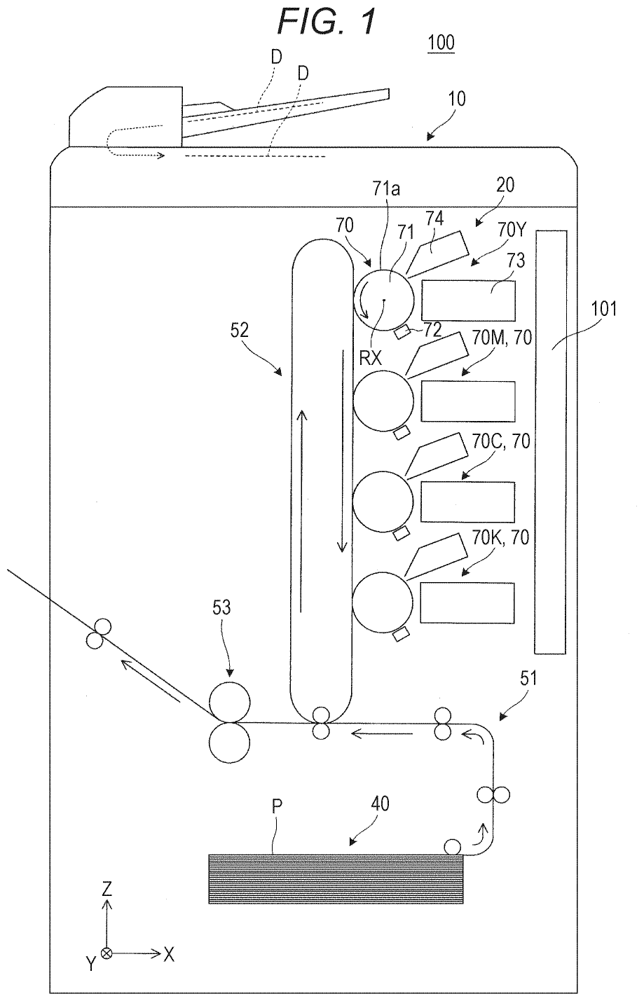

As illustrated in FIG. 1, an image forming apparatus 100 of a first embodiment is used as a digital copying machine or the like and includes, for example, an image reading unit 10 that reads a color image formed on a document D, an image forming unit 20 that forms an image corresponding to the document D on a paper P, a paper feeder 40 that feeds the paper P to the image forming unit 20, a transfer unit 51 that transfers the paper P, and a control unit 101 that comprehensively controls operation of the entire apparatus.

The image forming unit 20 includes image forming units 70Y, 70M. 70C, and 70K provided for cyan, magenta, yellow, and black, respectively, an intermediate transfer unit 52 that forms a toner image obtained by combining the colors, and a fixing unit 53 that fixes the toner image.

In the image forming unit 20, the image forming unit 70Y is a part that forms an image of Y (yellow) color, and includes a photosensitive drum 71, a charging unit 72, an optical print head (optical writing device) 73, a developing unit 74, and so on. The photosensitive drum 71 forms a Y-color toner image, the charging unit 72 is disposed around the photosensitive drum 71 and charges a surface of the photosensitive drum 71 as a photoreceptor by corona discharge, the optical print head 73 irradiates the photosensitive drum 71 with light corresponding to the image of the Y-color component, and the developing unit 74 makes the toner of the Y-color component adhere to the surface of the photosensitive drum 71 to form a toner image from an electrostatic latent image. The photosensitive drum 71 has a cylindrical shape and rotates around a rotation axis RX. A cylindrical surface of the photosensitive drum 71 is a light receiving surface 71a on which an image formed by the optical print head 73 is formed.

The other image forming units 70M, 70C, 70K have a structure and functions similar to those of the image forming unit 70Y for Y color except that the color of the image to be formed is different, and therefore the description thereof is omitted. An image forming unit 70 means an arbitrary unit among the image forming units 70Y. 70M, 70C, 70K of four colors, and includes the photosensitive drum 71, the charging unit 72, the optical print head 73, and the developing unit 74 as elements adapted to each of the colors.

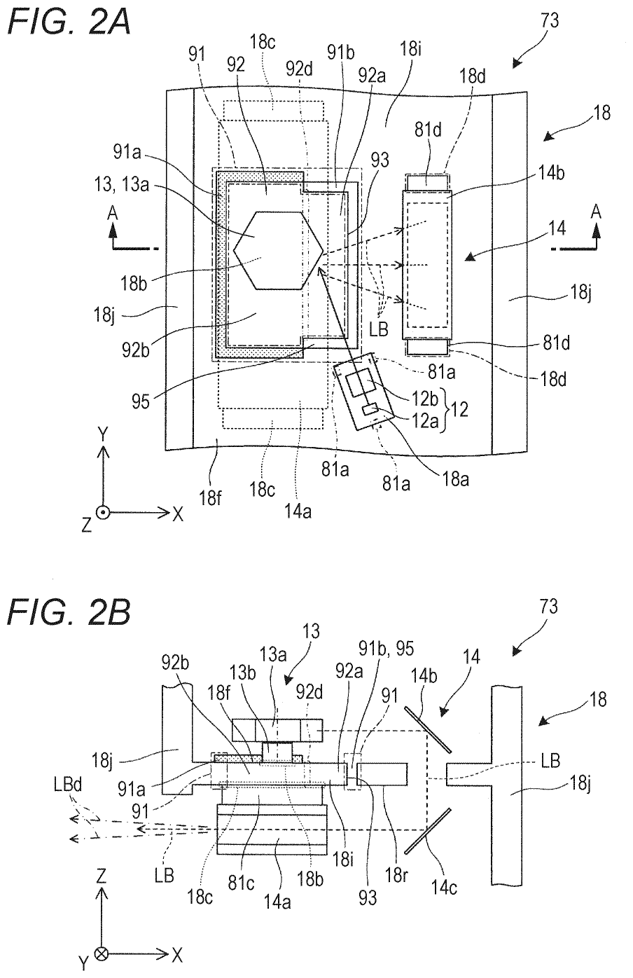

As illustrated in FIGS. 2A and 2B, the optical print head (optical writing device) 73 includes a light source device 12 that emits a light beam LB having a predetermined wavelength, a deflector 13 that deflects and scans a light beam LB emitted from the light source device 12, an optical scanning system 14 that guides an optical flux having passed through the deflector 13 onto the surface of the cylindrical photosensitive drum 71, and a housing 18 that supports and houses these optical elements. Here, the light source device 12 includes, for example, a light emitting element 12a such as a semiconductor laser, and an optical element 12b such as a lens, a mirror, or the like that shapes light emitted from the light emitting element 12a. The light emitting element 12a is controlled to emit light in synchronization with a rotation operation of the deflector 13 corresponding to image information. The deflector 13 has a rotary polygon mirror 13a that reflects the light beam LB from the light source device 12 toward the optical scanning system 14 side, and a motor unit 13b that rotates the rotary polygon mirror 13a. The optical scanning system 14 has a scanning lens 14a, also called an fθ lens, and optical path bending mirrors 14b. 14c. The direction of the light beam LB can be changed along a main direction parallel to XY by the rotary polygon mirror 13a. The scanning lens 14a is not limited to one constituted of a single lens element, and may be constituted of a plurality of lens elements. The mirrors 14b, 14c are for setting the emission direction of the light beam LB, and the number and disposition thereof can be appropriately set according to conditions such as specifications of the image forming unit 20.

The housing 18 is an integrally molded product made of, for example, an aluminum die cast, and has a support plate 18i that extends in a horizontal direction as a bottom surface, and a wall body 18j that supports the support plate 18i from a periphery and extends in a vertical direction. The support plate 18i is provided with a light source holder 18a fixing the light source device 12, a deflector holder 18b fixing the deflector 13, and element holders 18c, 18d fixing the optical scanning system 14. The light source device 12 is fixed to the light source holder 18a with fixing parts 81a interposed therebetween on a front side 18f of the support plate 18i. The deflector 13 is fixed to the deflector holder 18b with a fixing part 81b interposed therebetween on the front side 18f of the support plate 18i. A scanning lens 14a constituting the optical scanning system 14 is fixed to the element holder 18c with a fixing part 81c interposed therebetween on a back side 18r of the support plate 18i, and mirrors 14b. 14c constituting the optical scanning system 14 are fixed to the element holder 18d provided separately from the element holder 18c with a fixing part 81d interposed therebetween.

A vibration preventing frame 91 is formed on the support plate 18i of the housing 18 so as to surround the deflector 13. The vibration preventing frame 91 is disposed so as not to interfere with optical elements such as the scanning lens 14a and light beams passing through the periphery of the support plate 18i. The vibration preventing frame 91 has a vibration suppressor 91a and a vibration transmission blocker 91b. The vibration preventing frame 91 is rectangular, and the inside of the vibration preventing frame 91 is an enclosed inner region 92. The enclosed inner region 92 supports the deflector 13 and is substantially surrounded by the vibration suppressor 91a and the vibration transmission blocker 91b. The support plate 18i has a movable flat portion 92a having a peninsular shape facing the vibration transmission blocker 91b, and a rectangular plate portion 92b surrounded by the vibration suppressor 91a and the movable flat portion 92a in the enclosed inner region 92. The vibration suppressor 91a is a rib-shaped portion that is integrally molded with the housing 18 or the support plate 18i and protrudes on the front side 18f, and is constituted of three linear protruding portions surrounding the rectangular plate portion 92b from three directions. In this case, the component cost and the number of assembly operation steps of the vibration suppressor 91a can be reduced by integral molding compared to a case where the component is divided into a plurality of members, which can contribute to cost reduction. The vibration transmission blocker 91b is a hole or notch 95 penetrating from the front side 18f to the back side 18r, and includes a three-sided linear opening portion or a U-shaped opening portion surrounding the movable flat portion 92a from three directions. In this case, it is possible to increase vibration blocking efficiency in the vibration transmission blocker 91b.

The movable flat portion 92a is fixed to the rectangular plate portion 92b at a root portion 92d. That is, the root portion 92d is a fixing end, and an end portion 93 functions as a free end and vibrates in a Z direction corresponding to the sub-direction of scanning. Here, a vibration mode of the movable flat portion 92a having a peninsular shape at an excitation frequency of the deflector 13 is vibration in a primarily out-of-plane direction having a node near the root portion 92d of the movable flat portion 92a. Here, the out-of-plane direction corresponds to the sub-direction or the Z direction. As described above, by setting a vibration mode in which the end portion 93 of the movable flat portion 92a oscillates at the excitation frequency by the deflector 13, the effect of concentrating vibrations of the deflector 13 on the movable flat portion 92a can be obtained more reliably.

The vibration suppressor (rib-shaped portion) 91a has a role of suppressing vibrations of the rectangular plate portion 92b in the enclosed inner region 92 by increasing rigidity in the region of the support plate 18i surrounded by the vibration suppressor 91a. The vibration transmission blocker 91b or the hole 95 allows vibrations of the end portion 93 of the movable flat portion 92a, so as to prevent vibrations in the enclosed inner region 92 to leak out of the enclosed inner region 92 via the vibration transmission blocker 91b. Outside the enclosed inner region 92, the light source holder 18a supports the light source device 12 having optical sensitivity in the Z direction, which is a vibration direction of the housing 18 or the support plate 18i, in a state that vibrations are suppressed. Consequently, vibrations of the light source device 12 caused by the deflector 13 are prevented, that is, shifts of the image formation position by fast deflection of the emission direction of the light beam LB with respect to the ±Z direction namely, the sub-direction, and decrease in image quality are prevented. If vibrations of the deflector 13 are directly transmitted to the light source device 12 with sufficient intensity, an emission direction of a light beam LBd is deflected so as to vibrate in the Z direction, as conceptually illustrated by one-dot chain lines in FIG. 2B. Outside the enclosed inner region 92, the element holder 18c supports the scanning lens 14a as an optical element having optical sensitivity in the Z direction, which is the vibration direction of the housing 18 or the support plate 18i, in a state that vibrations are suppressed. Consequently, vibrations of the scanning lens 14a caused by the deflector 13 are prevented, that is, shifts of the image formation position by fast deflection of the emission direction of the light beam LB with respect to the ±Z direction and decrease in image quality are prevented. Outside the enclosed inner region 92, the element holder 18d has mirrors 14b, 14c as optical elements having optical sensitivity in the Z direction which is the vibration direction of the housing 18 or the support plate 18i, in a state that vibrations are suppressed. Consequently, deterioration in image quality due to vibrations of the mirrors 14b, 14c caused by the deflector 13 is prevented.

Operation of the optical print head 73 will be described. The light beam LB emitted from the light source device 12 changes in emission direction while being incident on and reflected by the rotary polygon mirror 13a rotating in the deflector 13. The light beam LB reflected by the rotary polygon mirror 13a is bent by the mirrors 14b. 14c and is incident on the scanning lens 14a. The light beam LB that has passed through the scanning lens 14a is incident on the surface of the photosensitive drum 71 to form an electrical latent image.

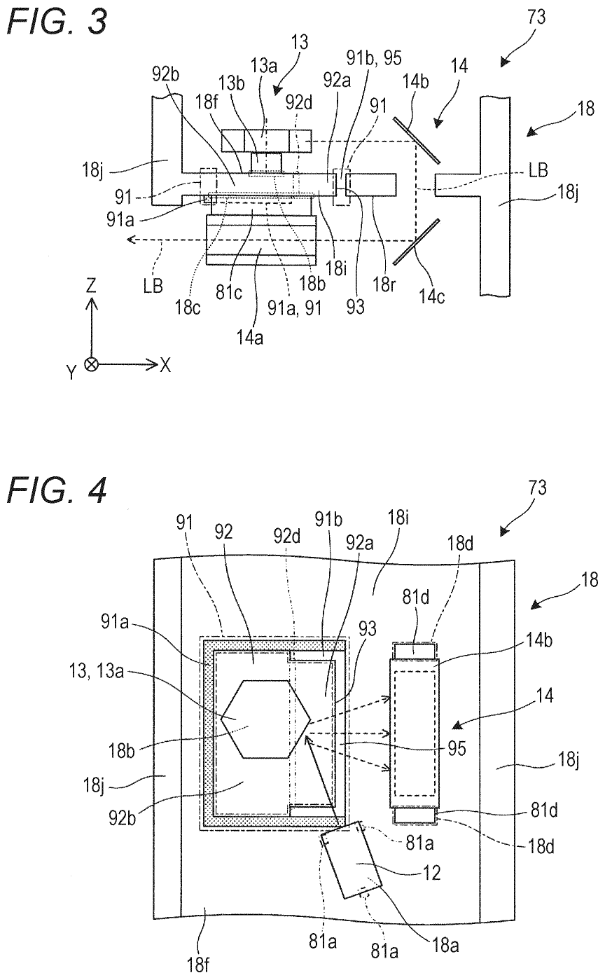

As illustrated in FIG. 3 as a modification example, the vibration suppressor (rib-shaped portion) 91a can be a rib-shaped portion that protrudes from the back side 18r of the housing 18 or the support plate 18i rather than the front side 18f of the housing 18 or the support plate 18i. Also in this case, the vibration suppressor 91a is integrally molded with the housing 18 or the support plate 18i, and suppresses vibrations of the rectangular plate portion 92b in the enclosed inner region 92. In this case, taking advantage of the degree of freedom of disposition of the vibration suppressor 91a, the degree of freedom of disposition of optical elements and optical paths on the support plate 18i can be increased, and a space on the housing 18 can be effectively utilized.

As illustrated in FIG. 4 as a modification example, the vibration suppressor (rib-shaped portion) 91a extends outside the enclosed inner region 92, along the vibration transmission blocker 91b or the hole 95, to a region near the vibration transmission blocker 91b. That is, in part of the vibration preventing frame 91, there is a region where the vibration suppressor 91a and the vibration transmission blocker 91b overlap and extend close to each other. The vibration suppressor 91a and the vibration transmission blocker 91b are overlapped to enhance rigidity. In addition, although illustration is omitted, the vibration suppressor 91a and the vibration transmission blocker 91b may be slightly spaced apart. That is, a part of the vibration preventing frame 91 may be spaced apart and open.

Although illustration is omitted, outlines of the vibration preventing frame 91 and the enclosed inner region 92 are not limited to a quadrangle, and can be, for example, an ellipse, a five or more sided polygon, or a chamfered rectangle. Similarly, the movable flat portion 92a is not limited to a quadrangle, and may include a curve, a chamfer, a notch, or the like. A cross-sectional shape that traverses a longitudinal direction of the vibration suppressor (rib-shaped portion) 91a is not limited to a rectangle, and may be various shapes such as a semicircular arc shape.

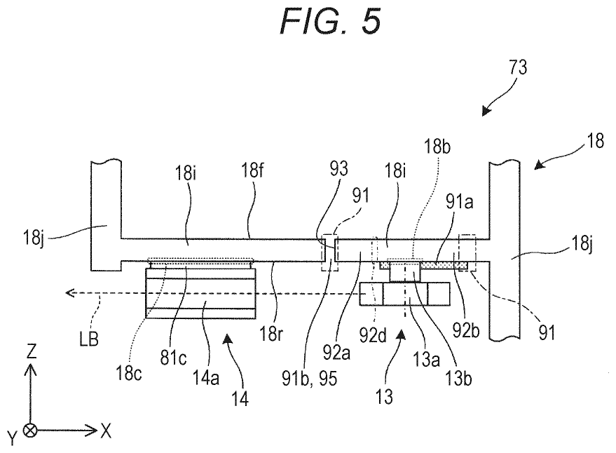

As illustrated as a modification example in FIG. 5, the mirrors 14b, 14c may be omitted, and the light beam LB reflected by the rotary polygon mirror 13a may be directly incident on the scanning lens 14a. In this case, the scanning lens 14a is not disposed on an opposite side across the support plate 18i of the deflector 13, but the deflector 13 is supported in the enclosed inner region 92 by being fixed to the back side 18r in the rectangular plate portion 92b. On the other hand, the scanning lens 14a is supported outside the enclosed inner region 92.

Hereinafter, simulation results presuming a specific structure of the optical print head 73 will be described.

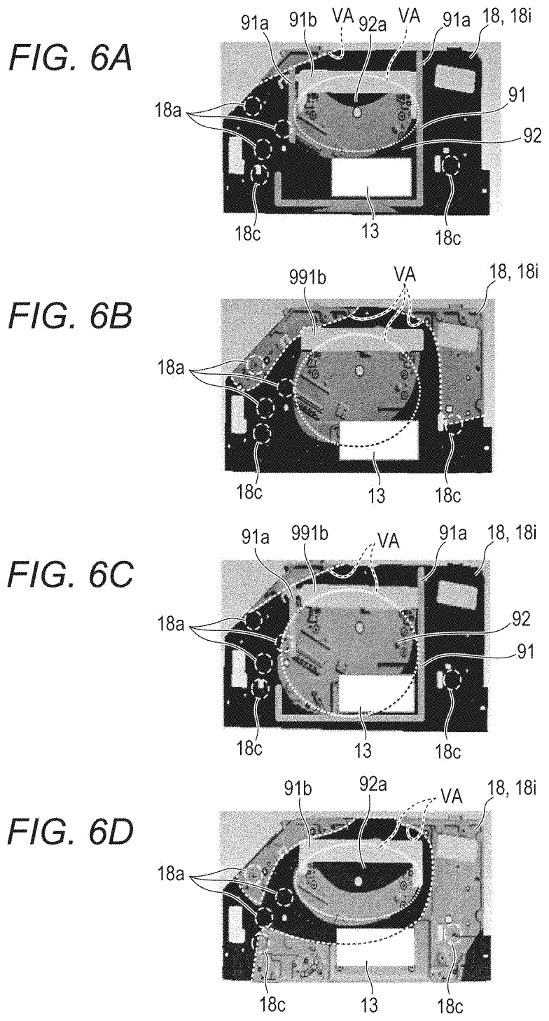

FIG. 6A illustrates a result of performing vibration SIM (frequency response analysis) on the optical print head 73 of the embodiment, and the light source holder 18a for the light source device 12 and an element holder 18c for the scanning lens 14a are disposed outside a region surrounded by a broken-line circle where there are large vibrations. The vibration suppressor 91a, which is a rib-shaped portion, substantially surrounds the enclosed inner region 92 but is partially missing. An analysis condition of the vibration SIM is that an excitation force is applied in a direction perpendicular to the figure to the position where the deflector 13 is installed, that is, the deflector holder 18b at an excitation frequency (650 Hz) generated by the deflector 13 when the optical print head 73 is in operation. Contour elements (contrast distribution) of FIG. 6A represent the magnitude or amplitude of vibrations in a direction perpendicular to the figure of each part of the housing 18 or the support plate 18i. A vibration region VA where vibrations are relatively large is limited to the movable flat portion 92a in the enclosed inner region 92. That is, the result represents that, by concentrating vibrations on the movable flat portion 92a having a peninsular shape, it is possible to keep vibration energy in the enclosed inner region 92 and to suppress vibrations from being transmitted outside the enclosed inner region 92.

FIG. 6B illustrates a result of performing vibration SIM (frequency response analysis) for an optical print head of comparative example 1. In this case, unlike the embodiment illustrated in FIG. 6A, the vibration preventing frame 91 is not formed and the enclosed inner region 92 does not exist. Moreover, although an opening hole 991b is formed, the movable flat portion 92a having a peninsular shape does not exist. The vibration region VA where vibrations are relatively large widely spreads in a central portion and an outer edge portion of the support plate 18i of the housing 18, and also extends to the light source holder 18a.

FIG. 6C illustrates a result of vibration SIM (frequency response analysis) for an optical print head of comparative example 2. In this case, the vibration preventing frame 91 is formed and the enclosed inner region 92 exists. However, although an opening hole 991b is formed, there is no movable flat portion 92a having a peninsular shape. The vibration region VA where vibrations are relatively large widely spreads outside the enclosed inner region 92 and extends to the central portion and the outer edge portion of the support plate 18i of the housing 18, and also extends to the light source holder 18a.

FIG. 6D illustrates a result of vibration SIM (frequency response analysis) for an optical print head of comparative example 3. In this case, the vibration transmission blocker 91b is formed, and there is a movable flat portion 92a having a peninsular shape. However, the vibration suppressor 91a is not formed, and the vibration preventing frame 91 does not exist. The vibration region VA where the vibrations are relatively large widely spreads in the central portion and the outer edge portion of the support plate 18i of the housing 18, and also extends to the light source holder 18a and the element holder 18c.

In the optical print head (optical writing device) 73 or the image forming apparatus 100 of the embodiment described above, since the support plate 18i of the housing 18 has the enclosed inner region 92 that is substantially surrounded by the vibration suppressor (rib-shaped portion) 91a and the vibration transmission blocker 91b or the hole 95 and supports the deflector 13, and has the movable flat portion 92a having a peninsular shape facing the vibration transmission blocker 91b in the enclosed inner region 92, it is possible to prevent vibrations from leaking out of the enclosed inner region 92 while blocking vibrations from the deflector 13 by the movable flat portion 92a. Further, since the element holders 18c. 18d for the scanning lens 14a and the mirrors 14b, 14c, which are optical elements having optical sensitivity in the Z direction which is the vibration direction of the housing 18, are disposed outside the enclosed inner region 92, and the light source holder 18a for the light source device 12, which is an optical element having optical sensitivity in the vibration direction of the housing 18, is disposed outside the enclosed inner region 92, it is possible to prevent deterioration of image quality by vibrations transmitted to the scanning lens 14a, which is an optical element having high vibration sensitivity of this type.

### Second Embodiment

Hereinafter, an image forming apparatus and an optical writing device according to a second embodiment will be described. Note that the image forming apparatus and the optical writing device according to the second embodiment are modifications of the image forming apparatus and so on according to the first embodiment, and items that are not particularly described are similar to those in the first embodiment.

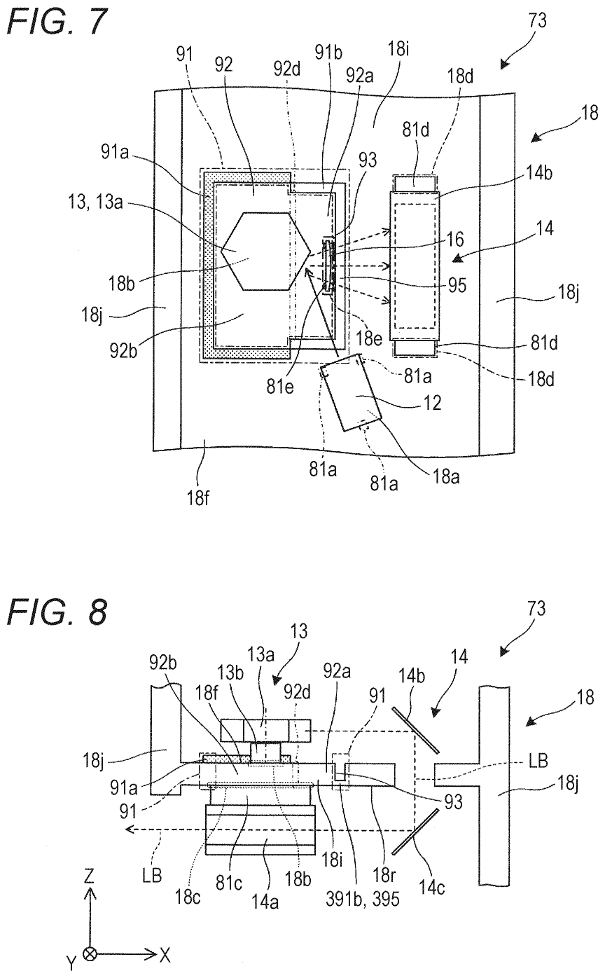

As illustrated in FIG. 7, in an optical print head (optical writing device) 73 of the second embodiment, an incident-side lens 16 is provided as a part of the optical scanning system 14 in front of the scanning lens 14a. The incident-side lens 16 is disposed on the movable flat portion 92a having a peninsular shape provided in the enclosed inner region 92 surrounded by the vibration preventing frame 91. The incident-side lens 16 is, for example, a columnar or wall-shaped lens, in which a cross section perpendicular to a Z direction in parallel to vibration of the movable flat portion 92a is the same shape at any position in the Z direction. The incident-side lens 16 is fixed to the movable flat portion 92a by a fixing part 81e in an element holder 18e, and vibrates at high speed in the Z direction together with the movable flat portion 92a. The incident-side lens 16 has sensitivity only in a horizontal XY direction (main direction) due to shape characteristics thereof, and has substantially no optical sensitivity in the Z direction (sub-direction) that is the vibration direction of the housing 18 or the movable flat portion 92a. In this case, by arranging this type of incident-side lens 16 having low vibration sensitivity in the enclosed inner region 92, a space on the housing 18 can be effectively utilized while suppressing influence on image quality. The incident-side lens 16 can be disposed not only on the movable flat portion 92a but also on the rectangular plate portion 92b. Further, the optical element having substantially no optical sensitivity in the Z direction disposed in the enclosed inner region 92 is not limited to a lens, and may be one having various optical functions such as a filter.

### Third Embodiment

Hereinafter, an image forming apparatus and an optical writing device according to a third embodiment will be described. Note that the image forming apparatus and the optical writing device according to the third embodiment are modifications of the image forming apparatus and so on according to the first embodiment, and items not particularly described are similar to those in the first embodiment.

As illustrated in FIG. 8, an optical print head (optical writing device) 73 of the third embodiment has a vibration suppressor 91a and a vibration transmission blocker 391b as the vibration preventing frame 91. The vibration transmission blocker 391b is not a hole as in the first embodiment, but is a thin region 395 in which a thickness of the housing 18 is thinner than surroundings. The thin region 395 largely elastically deforms, and the end portion 93 of the movable flat portion 92a is in a state close to the free end, and vibrates relatively largely in a Z direction.

In the optical print head 73 of the third embodiment, since the thin region 395 is provided as a part of the vibration preventing frame 91, it becomes easy to maintain rigidity of the entire housing 18 while suppressing leakage of vibration to the outside of the vibration preventing frame 91, making the optical print head strong against impact and load.

In the foregoing, the present invention has been described according to the embodiments, but the present invention is not limited to the above embodiments. For example, although the rib-shaped portion is provided on the support plate 18i of the housing 18 along the vibration preventing frame 91 as the vibration suppressor 91a, additional rib-shaped portions may be provided inside and outside the vibration preventing frame 91.

The vibration suppressor 91a is not limited to one of the front side 18f or the back side 18r, and can be formed on both the front side 18f and the back side 18r. In this case, the shapes of the both may be different.

The component disposition in the optical print head 73 of the above embodiments and the shape or thickness of the housing 18, and so on are merely examples, and the component disposition and so on can be changed as appropriate according to specifications of the optical print head.

In the above embodiments, the deflector 13 is constituted of a polygon mirror or a rotary polygon mirror 13a, and so on. However, other deflectors such as a galvanometer mirror also exhibit a similar effect. Further, the vibration suppressor 91a may be a part in which a reinforcing member such as a sheet metal is fixed to the housing 18. Furthermore, although only the frame portion of the housing 18 has been described, the housing 18 has a structure provided with a cover or the like for protecting the deflector 13 and so on.

The support plate 18i that supports the deflector 13 and the like is not limited to one being arranged in the horizontal direction, and may be one arranged in the vertical direction.

The image forming unit 20 or the optical print head (optical writing device) 73 described above can be incorporated not only in a printer but also in a digital copying machine.

According to an embodiment of the present invention, the vibration transmission blocker may reduce rigidity of the housing, but by extending the vibration suppressor that overlaps on an outside thereof to strengthen the rigidity, increase in vibration due to rigidity reduction outside the enclosed region can be suppressed.

According to another embodiment of the present invention, the image forming apparatus is provided with the optical writing device having the above-described characteristics, and can improve image quality by suppressing vibrations of the optical system.

Although embodiments of the present invention have been described and illustrated in detail, the disclosed embodiments are made for purposes of illustration and example only and not limitation. The scope of the present invention should be interpreted by terms of the appended claims.

What is claimed is:

1. An optical writing device comprising:
a deflector that deflects and scans light;
optical elements; and
a housing that holds the deflector and the optical element, wherein
a support plate of the housing has an enclosed inner region that is substantially surrounded by a vibration suppressor and a vibration transmission blocker and supports the deflector, and
the support plate also has a flat portion having a peninsular shape facing the vibration transmission blocker in the enclosed inner region, and an element holder for at least one or more of the optical elements having optical sensitivity in a vibration direction of the housing is disposed outside the enclosed inner region.

2. The optical writing device according to claim 1, wherein an element holder for the optical elements having substantially no optical sensitivity in the vibration direction of the housing is disposed on the flat portion having a peninsular shape facing the vibration transmission blocker.

3. The optical writing device according to claim 1, wherein the vibration suppressor is formed on one or both of a front side and a back side of the housing.

4. The optical writing device according to claim 1, wherein the vibration suppressor is a rib-shaped portion that is integrally molded with the housing.

5. The optical writing device according to claim 1, wherein the vibration transmission blocker is a hole provided in the housing.

6. The optical writing device according to claim 1, wherein the vibration transmission blocker is a region in which a thickness of the housing is thinner than surroundings.

7. The optical writing device according to claim 1, wherein a vibration mode of the flat portion having a peninsular shape at an excitation frequency of the deflector is vibration in an out-of-plane direction having a node near a root of the flat portion.

8. The optical writing device according to claim 1, wherein the vibration suppressor extends to a vicinity of the vibration transmission blocker outside the enclosed inner region.

9. An image forming apparatus comprising the optical writing device according to claim 1.
